(19) United States
(12) Patent Application Publication
(10) Pub. No.: US 2004/0010549 A1
(43) Pub. Date: Jan. 15, 2004

(54) Audio conferencing system with wireless conference control

(76) Inventors: Roger Matus, Boxborough, MA (US); Arthur Leondires, Atkinson, NH (US)

Correspondence Address: Samuels, Gauthier & Stevens LLP, Suite 3300, 225 Franklin Street, Boston, MA, 02110, US

(21) Appl. No.: 10/390,588

(22) Filed: Mar. 17, 2003

Related U.S. Application Data
(60) Provisional application No. 60/365,304, filed on Mar. 17, 2002.

(51) Int. Cl. G06F 15/16

(52) U.S. Cl. 709/204

(57) ABSTRACT

A wireless communication device communicates with an audio conferencing system via a wireless communication channel to initiate an audio conference hosted by the audio conferencing system. The wireless communication device includes a memory device that contains a contact list identifying a plurality of potential audio conference participants and their telephone numbers. A processor executes a wireless conferencing application and interfaces with the memory device to access the contact list, and transmits the contact list to a display for display to a user. An input device allows the user to select conference participants from the displayed contact list, and provide a selection signal to the processor indicative of the selected ones of the potential audio conference participants. The processor receives the selection signal and forms a conference list that identifies the selected ones of the potential audio conference participants and their telephone numbers. The processor outputs the conference list to a transceiver for transmission over the wireless communication channel to the audio conferencing system.

### PRIRITY INFORMATION

This application claims priority from U.S. provisional application Ser. No. 10/365,304, filed Mar. 17, 2002 and entitled “Audio Conferencing System With Wireless Conference Control”. This application is hereby incorporated by reference.

### CROSS REFERENCE TO RELATED APPLICATIONS

This application contains subject matter related to provisional application serial No. 60/287,442 also entitled “Audio Conferencing System with Wireless Conference Control”, filed Apr. 30, 2001. This application is hereby incorporated by reference.

### BACKGROUND OF THE INVENTION

The present invention relates to the field of audio conferencing systems, and in particular to an audio conferencing system that may be configured by a wireless device.

### SUMMARY OF THE INVENTION

Briefly, according to an aspect of the invention, A wireless communication device communicates with an audio conferencing system via a wireless communication channel to initiate an audio conference hosted by the audio conferencing system. The wireless communication device includes a memory device that contains a contact list identifying a plurality of potential audio conference participants and their telephone numbers. A processor executes a wireless conferencing application and interfaces with the memory device to access the contact list, and transmits the contact list to a display for display to a user. An input device allows the user to select conference participants from the displayed contact list, and provide a selection signal to the processor indicative of the selected ones of the potential audio conference participants. The processor receives the selection signal and forms a conference list that identifies the selected ones of the potential audio conference participants and their telephone numbers. The processor outputs the conference list to a transceiver for transmission over the wireless communication channel to the audio conferencing system.

These and other objects, features and advantages of the present invention will become apparent in light of the following detailed description of preferred embodiments thereof, as illustrated in the accompanying drawings.

### BRIEF DESCRIPTION OF THE DRAWINGS

FIG. 1 is a pictorial illustration of a conferencing system; and

FIG. 2 is a block diagram illustration of the portable wireless device (e.g., a PDA, integrated PDA/cellular device, etc) that includes an application program that executes within a processor/DSP of the wireless device to initiate conference calls.

### DETAILED DESCRIPTION OF THE INVENTION

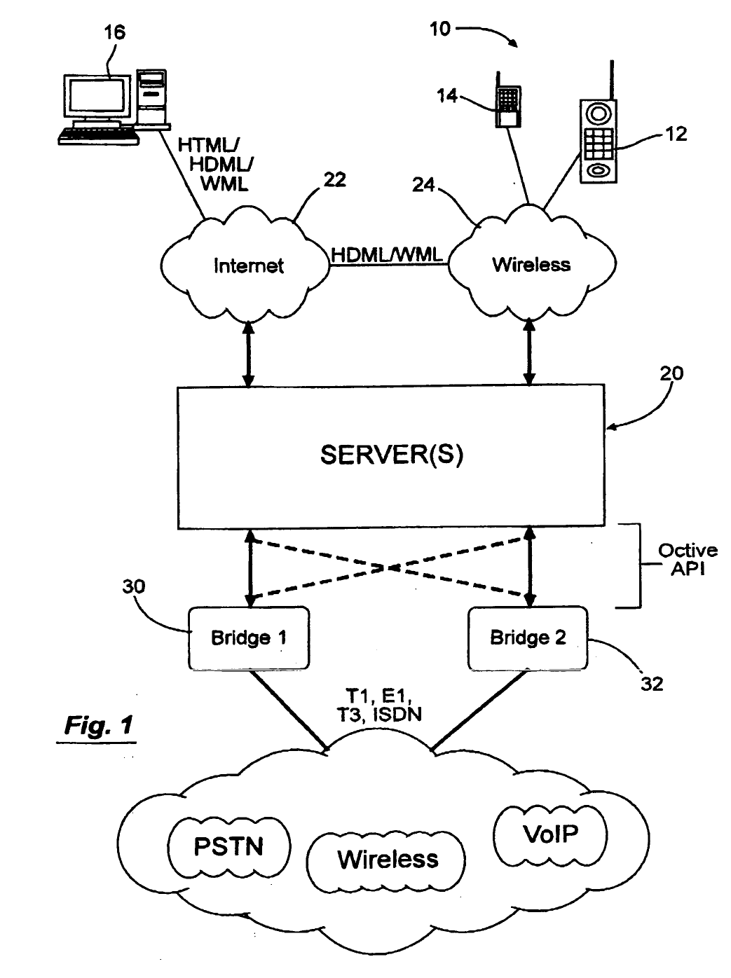

FIG. 1 is a pictorial illustration of a conferencing system. The conferencing system 10 may be configured by: (i) a wireless device such as a cellular phone 12 or (ii) a PDA 14 or (iii) via a conventional wireline device such as a computer 16 that accesses the Internet. The various wireless and wireline devices provide commands to and receive data from a conferencing server 20, via the respective data networks. The conference server is preferably configured and arranged as a redundant system, which includes a plurality of servers (e.g., a plurality of Sun Solaris servers) to provide redundant backup in the event of failure of one or more of the servers. The plurality of servers preferably includes a load balancer. The user uses the wireless or wireline communications channels to interface (e.g., with a browser) with the server 20 to perform functions such as conference control, administration (e.g., system configuration, billing, reports, . . . ), conference scheduling and account maintenance. Details of the server configuration shall be discussed hereinafter.

The system also includes a plurality of conference bridges 30, 32 such as for example the OCI-1000 conference bridge available from Octave Communications, Inc., the assignee of the present invention. The conference bridges 30, 32 are preferably arranged to provide system redundancy. Each of the conference bridges 30, 32 is configured and arranged to receive audio from conference participants via various audio communication channels such as T1, E1, T3 and ISDN. The server 20 communicates with the bridge(s) 30, 32 via an application programming interface (API). The details of the conferencing bridge shall not be discussed herein in the interest of brevity. However, details of the conferencing platform may be found in the applicant's co-pending application entitled “Scalable Audio Conference Platform” designated Ser. No. 09/532,602. Details of how a wireless device configures an audio conference via the server 20 shall now be discussed.

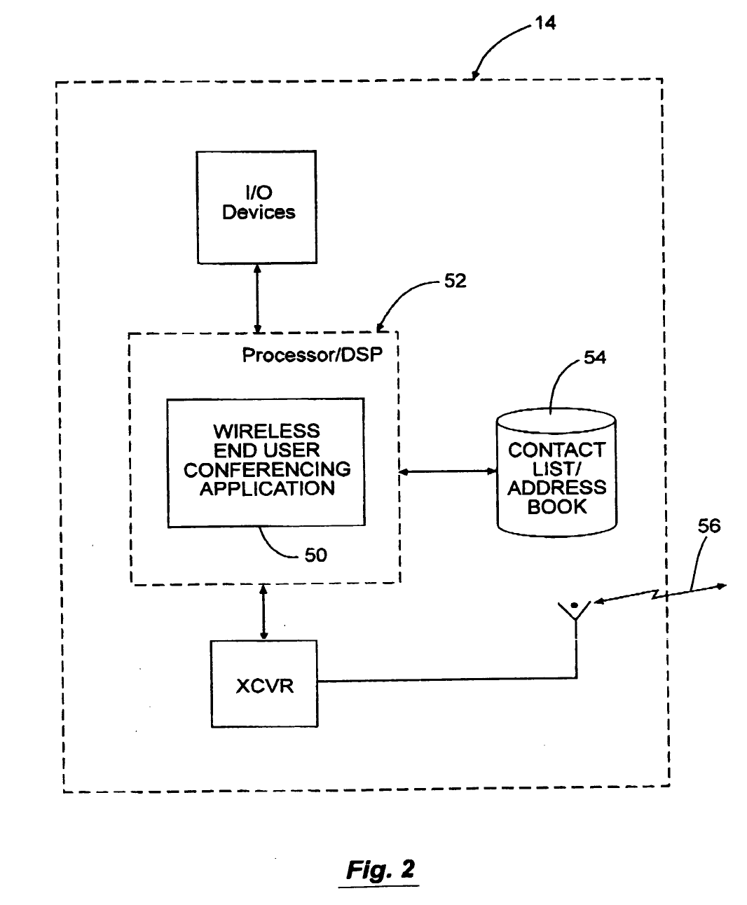

FIG. 2 is a block diagram illustration of the portable wireless device 14 (e.g., a PDA, integrated PDA/cellular device, etc) that includes an application program 50 that executes within a processor/DSP 52 of the wireless device 14 to initiate conference calls. The wireless device 14 may be a device that uses a Palm O/S, a Microsoft Windows Powered Pocket PC, a Symbian based O/S, or a telephone with built-in phone list. The application 50 accesses and retrieves information from a database 54 on the portable device 14, such as a Microsoft Outlook contact list or a Palm address book. The application 50 enables the user to select groups, individuals, or specific identification information from the list. For example, the application 50 may retrieve the phone numbers and/or email addresses for the individuals stored in the phone list. The user may also add new numbers or addresses by entering them into the system. The selected and added information creates a new “participant list.” One participant may be identified as the list owner or “moderator.” This list owner or “moderator” may be entered manually, identified from the list, or automatically identified based on “owner information” stored in the device, or it may be automatically identified based on a unique identifier, such as an email address, IP address, or phone number, used to operate the advice. Billing information may also be generated from “owner information” or the “moderator” identification.

The application 50 on the portable device 13 allows the user to send the “participant list” and other relevant information, such as “moderator” and “owner information” to a server (see FIG. 1) over a wireless communication channel 56 to take a specified application.

The server 20 (FIG. 1) then initiates telephony related actions based on the data transmitted from the handheld device 14, such as for example initiating telephone calls, creating a single conference call, or initiating a telephone call at a later time that was indicated by the portable device. The system can also send a text message, such as for example via SMS, MMS, email, or instant messenger, to notify participants of an impending phone call or to request that they call a specific number or take another specific action. The server will also use the information to provide relevant information to be used for billing the call.

The application, which may use Microsoft Windows Powered Pocket PC handheld devices, is integrated with the Microsoft Pocket Outlook contact list. Users click a check box next to the names of contacts they wish to call. Then, by clicking the “CALL NOW” button (not shown), the wireless handheld device 14 contacts the server 20 (FIG. 1), which contacts the selected contacts. The contacts are automatically joined together in a call. For scheduled conferences, the application will integrate with Microsoft Pocket Outlook calendar to enable for scheduled conferences with an appointment request sent out via Microsoft Outlook.

This application has several features, including: (1) the distributed nature of creating a conference call between an application running on a portable device (e.g., 14) and an application running on the conferencing server 20, and (2) the initiation of a centralized voice application using data transmitted to it based on information stored on a portable device.

Significantly, the present invention allows a user to easily configure conference calls via a wireless device. Although the present invention has been discussed in the context of a conferencing system 10 as illustrated in FIG. 1, one of ordinary skill will recognize that the present invention may be used is various audio conferencing systems. For example, the system of course does not have to be configured as a redundant system. In addition, it is contemplated that all audio conferencing systems will find it desirable to configure audio conferences via a wireless device.

Although the present invention has been shown and described with respect to several preferred embodiments thereof, various changes, omissions and additions to the form and detail thereof, may be made therein, without departing from the spirit and scope of the invention.

What is claimed is:

1. A wireless communication device that communicates with an audio conferencing system via a wireless communication channel to initiate an audio conference hosted by the audio conferencing system, said wireless communication device comprising:
a memory device that contains a contact list identifying a plurality of potential audio conference participants and their telephone numbers;
a display;
a transceiver;
a processor that executes a wireless conferencing application and interfaces with said memory device to access said contact list, and transmits said contact list to said display for display to a user; and
an input device that allows the user to select conference participants from said displayed contact list, and provides a selection signal to said processor indicative of the selected ones of said potential audio conference participants,
wherein said processor receives said selection signal and forms a participant list that identifies the selected ones of said potential audio conference participants and their telephone numbers, and said processor outputs said participant list to said transceiver for transmission over the wireless communication channel to the audio conferencing system.
